(19) United States
(12) Patent Application Publication
(10) Pub. No.: US 2004/0236941 A1
(43) Pub. Date: Nov. 25, 2004

(54) Method for secure transfer of information

(76) Inventor: Bernardo Nicolas Sanchez, Toronto (CA)

Correspondence Address: MARKS & CLERK, 1075 NORTH SERVICE ROAD WEST, SUITE 203, OAKVILLE, ON, L6M 2G2, CA

(21) Appl. No.: 10/484,924

(22) PCT Filed: Jul. 5, 2002
(86) PCT No.: PCT/CA02/01020

(30) Foreign Application Priority Data
Jul. 24, 2001 (CA) 2353738

(51) Int. Cl. H04L 9/00

(52) U.S. Cl. 713/155; 713/171

(57) ABSTRACT

A method for secure transfer of information is provided which provides secure transfers of confidential information between an information requestor and an information source, which is controlled by a central party. The details of the information transfer are related to transaction keys and the transfer of information is controlled by having access to the specific transaction keys. In this fashion, information can be provided from one party to the next while the central party maintains control of the transfer by controlling access to the transaction keys. In this fashion, the central party is able to control and/or restrict the release of confidential information.

### FIELD OF THE INVENTION

The present invention generally relates to a method for effecting the electronic transfer of information, and in particular, to a method for controlled, secure transfers of information electronically between authorized parties.

### BACKGROUND OF THE INVENTION

The evolution of computerized transfers of information using networked computers, such as for example, over the Internet, has resulted in an ever increasing amount of data being transferred electronically between parties. With this increase in electronic transactions, the opportunities for unwanted exposure of confidential information has also increased. In particular, a significant area of concern is the inadvertent and/or unwanted release of personal information.

For example, an individual may wish to release confidential information from a doctor or medical facility to an insurance company, and it may be convenient to release this information electronically. However, the individual may wish to control the release of this information to only the parties of interest.

While encryption methods are commonly used to make theft of this information more difficult, not all systems use such encryption methods, and even with encryption methods in place, the information might still be obtained by sophisticated abusers of the system as the information is passed from node to node and therefore might be intercepted at multiple points on the system.

Accordingly, there is increasing concern over the release of confidential information over networked computer systems.

In our co-pending Canadian patent application No. 2347396 a system for secure, anonymous electronic financial transactions is described which relies on the generation of a transaction key which is used by two financial institutions, and a purchaser and seller, in order to confirm payment for goods or services electronically without releasing credit card information to the seller or to the seller's financial institution.

A similar system is used herein to effect the controlled, secure transfer of information between parties.

### SUMMARY OF THE INVENTION

Accordingly, it is a principal object of the present invention to provide a secure method for the electronic transfer of information between parties.

A further object of the present invention is to provide a method for the electronic transfer of information between parties which is controlled by a central party or individual.

The foregoing objects are attained by a system wherein a unique transaction key is generated between a central party, an information supplier, and an information requester, wherein said transaction key is utilized to control the transfer of information between the information supplier and the information requester. The transfer of information is controlled so that only parties authorized by the central party may act as information suppliers and/or information requesters.

Accordingly, the present invention provides a method for the secure transfer of information electronically, which method comprises the steps of:

(a) having an information requestor prepare a first request for information and providing said first request and a first transaction key related to said first request, to a central party;

(b) having said central party prepare a second request for said information and providing said second request and a second transaction key related to said second request, to an information source;

(c) having said information source provide said information to said central party and having said information source relate said information to said second transaction key;

(d) having said central party authorize release of said information to said information requestor;

(e) having said central party provide said information to said information requestor and having said central party relate said information to said first transaction key; and

(f) having said information requestor access said information related to said first transaction key.

Thus, a first advantage of the system of the present invention, is that the central party has control over a request for information from a information requestor, and can thus decide whether the information request is valid and therefore can be transferred to a information source. Also, while the information requester might specify the preferred source of the information, the central party can control and decide which information source to direct the request for information.

A second advantage of the system of the present invention is that the central party can control release of the information to the information requester.

A third advantage of the system of the present invention is that the transfer of information may be conducted anonymously in that the information requestor may not know any details regarding the information source.

It should be noted, however, that the central party may opt not to review the information prior to it being sent to the information requestor. With this option, the second transaction key can be identical to the first transaction key so that information is provided by the information source directly to a transaction key which is accessible by the information requestor.

Accordingly, the present invention also provides a method for the secure transfer of information electronically, which method comprises the steps of:

(a) having an information requestor prepare a first request for information and providing said first request and a first transaction key related to said first request, to a central party;

(b) having said central party prepare a second request for said information and providing said second request and said first transaction key related to said second request, to an information source;

(c) having said information source provide said information and having said information source relate said information to said first transaction key;

(d) having said information requestor access said information related to said first transaction key.

It should also be noted that the information requestor may provide a request for a variety of information, and that the information may need to be collected from a number of different information sources. Preferably, each portion of the information request could be transmitted to the relevant information source, each with its own related second transaction key. When information is received from any one of the information sources, it can be forwarded by the central party to the related first transaction key, where the multiple pieces of information can be collected and stored until accessed by the information requestor.

Further, in accordance with the goals of the present invention, and as a second feature, the present invention also provides an information transfer bridging system which facilitates the transfer of information between an information requester and an information source, through a central party, in accordance with the method described hereinabove with respect to the present invention.

Other features of the present invention, as well as other objects and advantages attendant thereto, are set forth in the following description and the accompanying drawings in which like reference numerals depict like elements.

### BRIEF DESCRIPTION OF THE DRAWINGS

Embodiments of the system of the present invention will now be described, by way of example only, by reference to the following drawings wherein:

FIG. 1 is a schematic drawing illustrating the steps of a transfer of information conducted in accordance with the present invention; and

FIG. 2 is a schematic drawing illustrating an alternative arrangement for the transfer of information conducted in accordance with the present invention.

### DETAILED DESCRIPTION

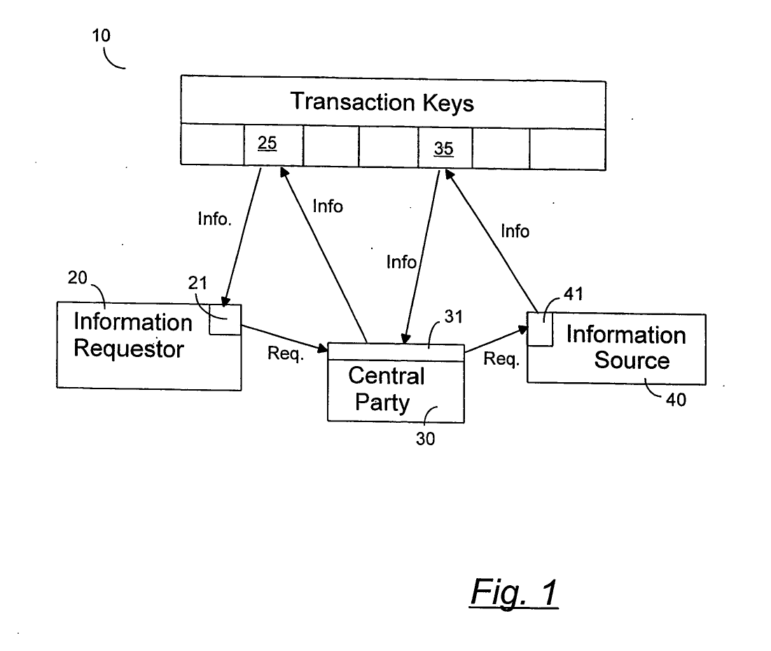

FIG. 1 is a schematic representation (10) of the system of the present invention. To start the process, an information requester (20) provides a first request for information to a central party (30). The information requestor (20) may be any individual, business or other organization which requires information from central party (30). Accordingly, the information requestor might be, for example, an insurance company, a bank, a government organization, a potential employer, a credit card company, a telephone company, or the like. The request for information might be generated by an individual, but might also be generated by an automated system.

However, it should be noted that the request for information typically results from an initial request from the central party to have the information requestor take some action. For example, the information requestor may request medical information about the central party as a result of an application by the central party for insurance.

The central party (30) is typically an individual but might also be a business or some other organization which requires the transfer of information from one party to another.

The first request for information is accompanied by a transaction key (25), and in this embodiment, a password is provided to the central party for accessing the transaction key (25).

The term “transaction key”, when used in the practise of the present invention, acts as a access code to identify a specific file location in the storage area on a computerized system. The transaction key will preferably be an alphanumeric code which is preferably a unique number for that transaction. This number may be randomly generated, or may a fixed number (such as, for example, the case of a automated machine which might always use a single transaction key). The transaction key might also be a fixed, sequential key (e.g. a fixed first portion to identify the information requestor, or central party, and a series of sequential numbers to identify, for example, different staff members). Preferably, imbedded in the first transaction key is a code to uniquely identify the information requestor so that this information does not need to be inputted later.

A time limit might also be established for the transaction key, —for improved security—so that the transfer of information must be completed within a certain time frame, or else the transaction key is no longer valid. The transaction key can also be established to include a time feature so that information stored therein can be destroyed after a pre-set time period if it has not been transferred. In this fashion storage of confidential information on the computerized system may be minimized.

Preferably, access to the transaction key is controlled by a security feature, such as, for example, password protection or the like.

The first request for information may be established between the information requester (20) and the central party (30) in person, but may also be established using, for example, the telephone, a computer with a direct link between the information requestor and the central party, or using a computer over a networked system, such as for example the system currently referred to as the Internet. A request for information might also be established by having the central party (30) be located in the vicinity of an automated machine, a computerized terminal, or other system for requesting information.

The central party (30) then provides the same, or a similar, request for information to an information source (40). The information source (40) can be any of a variety of sources of information, and is most likely a source of confidential information. This might include, for example, a doctor or medical facility with medical information, a bank or credit card company, a government organization, or the like.

The central party (30) also provides a second transaction key (35) with, in this embodiment, a password, to the information source (40). While the central party (30) could merely provide the information source with the first transaction key (25) (so that the first and second transaction key are the same)—with the relevant password—it is preferred that a separate second transaction key (35) be established in order for the central party (30) to maintain control of the transfer of information.

Should the central party not wish to exercise this control, the first transaction key (25) can be provided to the information source who can then transfer information directly to the first transaction key (25) where it is immediately accessible to the information requestor (20).

However, it is preferred that a second transaction key (35) be established.

Once the request for information is received, the information source (40) assembles the information into an information packet. The information packet is then sent electronically to the second transaction key (35) using the password information provided by central party (30). The central party (30) may or may not be given access to view the information contained in the information packet. Also, the central party may or may not be given authorization to amend, edit, or add additional information to the information contained in the information packet.

Preferably, however, the central party (30) is not given the ability to review or change the information in the information packet so that the information requestor (20) can be certain that the information contained in the information packet is the exact information provided by the information source (40). Alternatively, the central party might only be given limited ability to amend or edit the information, and still more preferably, the information source and/or the information requester would be able to review such amendments or editing.

The central party (30) then forwards the information packet to the first transaction key (25) together with the password supplied by the information requestor (20). The information requestor (20) then accesses the information packet in order to obtain the information originally requested.

In this manner, the central party is able to arrange for confidential information to be transferred from an information source to an information requestor in a fashion that is controlled by the central party. Through the use of transaction keys, access to the information is limited to only those who know the specific transaction keys, and preferably, to those who also know or can comply with the other relevant security features, as discussed hereinbelow. It is not necessary that the information source and the information requestor be aware of the identity of each other. Accordingly, the central party can also control the release of this information.

The system preferably also provides for one or a series of “alerts” to be generated to any one of, or all of, the information source, information requestor, and/or the central party. These “alerts” might be in the form of e-mail messages, form letters, facsimiles and the like, to indicate that information has been provided related to a transaction key. In this fashion, the parties can review whether information has been forwarded to the other parties, or whether the information request has been refused, or the like.

Contact between the information requestor, the central party and/or the information source might be established using a device such as, for example, a standard telephone. More preferably, however, the contact is established using an Internet-enabled cellular telephone, a computer, a personal digital assistant (PDA), or generally any device which can gain access to an Internet connection, or to an IVR (interactive voice response) application, or the like.

Contact between the information requester, the central party and/or the information source, and contact with the computerized system for establishing the transaction keys, and the like, is preferably conducted using software (and, if necessary, hardware), designed to facilitate correspondence between the parties. In the embodiment shown in FIG. 1, communication between the information requestor (20), the central party (30) and the information source (40), is conducted by specific software available to each party and generally designated as “21”, “31” and “41” respectively.

Access to the information might be controlled by passwords but might also be controlled by other security features such as, for example, by user-ids, passwords, PIN numbers or the like, or may simply be controlled and restricted to only those who have a specific particular device, such as a specific cellular telephone.

Other security features might include the use of current PKI (Public Key Infrastructure) technology, but might also include other current or future verification and identification technologies, such as, for example, digital thumb printing or retinal scans, or the like.

The transaction keys might be provided orally, or by simply posting the fixed transaction key, and/or other information on the automated machine. This information can then be inputted to the purchaser's access device manually. Preferably, however, the information requestor is able to transmit the transaction key directly to a computerized device of the central party, by for example, direct wire transmission, IR transmission and/or a proximity device which the purchaser's device could read.

Information regarding the second transaction key might be transmitted to the information source in a similar manner.

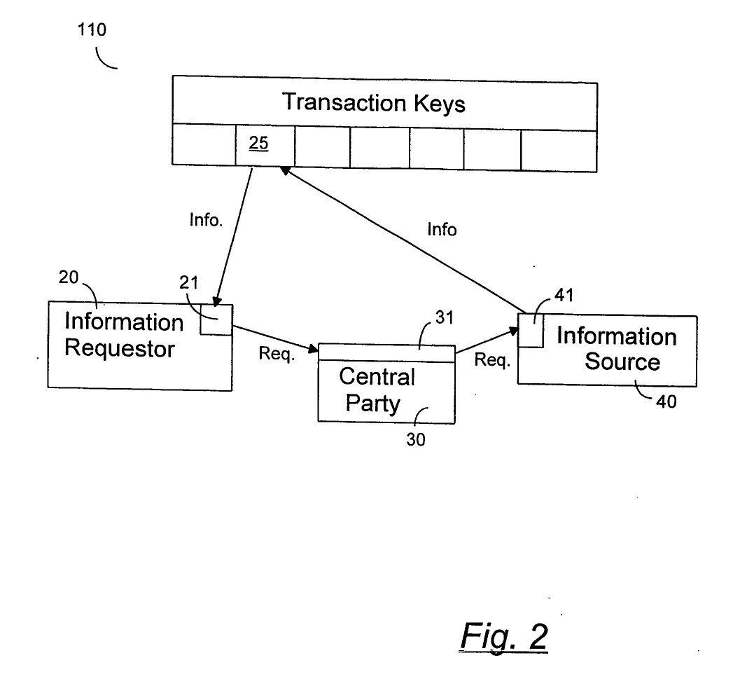

FIG. 2 depicts a schematic drawing (110) of an alternative arrangement for transferring information wherein the first and second transaction keys are identical. In FIG. 2, an information requestor (20) provides a first request for information to a central party (30), which request is accompanied by first transaction key (25). The central party (30) then provides the same, or a similar request for information to an information source (40) together with the first transaction key (25). The information source assembles the information into an information packet which is sent electronically to the first transaction key (25) where it can be accessed by the information requestor. The central party might be given access to the information in order to review the information, but more likely, is merely informed of the transfer through an e-mail alert, for example.

Thus, it is apparent that there has been provided, in accordance with the present invention, a method for secure transfer of information which fully satisfies the means, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

The embodiments of the invention in which an exclusive property or privilege is claimed are defined as follows:

1. A method for the secure transfer of information electronically, which method comprises the steps of:
(a) having an information requestor prepare a first request for information and providing said first request and a first transaction key related to said first request, to a central party;
(b) having said central party prepare a second request for said information and providing said second request and a second transaction key related to said second request, to an information source;
(c) having said information source provide said information to said central party and having said information source relate said information to said second transaction key;
(d) having said central party authorize release of said information to said information requestor;
(e) having said central party provide said information to said information requestor and having said central party relate said information to said first transaction key; and
(f) having said information requestor access said information related to said first transaction key.

2. A method as claimed in claim 1 wherein said information requestor is an individual, a business or other organization which requires information from said central party.

3. A method as claimed in claim 2 wherein said information requestor is an insurance company, a bank, a government organization, a potential employer, a credit card company, or a telephone company.

4. A method as claimed in claim 1 wherein said first request for information is generated by an individual.

5. A method as claimed in claim 1 wherein said first request for information is generated by an automated system.

6. A method as claimed in claim 1 wherein said central party is an individual.

7. A method as claimed in claim 1 wherein said central party is a business or some other organization which requires the transfer of information.

8. A method as claimed in claim 1 wherein said information source is a source of confidential information.

9. A method as claimed in claim 1 wherein said information source is a doctor or medical facility with medical information, a bank or credit card company, or a government organization.

10. A method as claimed in claim 1 wherein said first or said second transaction keys are an alphanumeric code

11. A method as claimed in claim 10 wherein said first or said second transaction keys are a unique number for that transaction.

12. A method as claimed in claim 1 wherein said first transaction key contains an imbedded code to uniquely identify the information requestor.

13. A method as claimed in claim 1 wherein said transmission key is transmitted from the information requestor directly to a computerized device of the central party, or directly from the central party to a computerized device of the information source, by direct wire transmission, IR transmission, or by a proximity device which the purchaser's device could read.

14. A method as claimed in claim 1 wherein access to the information is controlled by a security measure.

15. A method as claimed in claim 14 wherein said security measure is a user-id, a password, a PIN number, or wherein access to the information is restricted to only those who have a specific device.

16. A method as claimed in claim 14 wherein said specific device is a specific cellular telephone.

17. A method as claimed in claim 1 wherein said first or said second request for information, with their related transaction keys, additionally include a password for accessing said first or said second transaction key.

18. A method as claimed in claim 1 wherein said first or said second transaction key includes a time limit wherein the transfer of information must be completed within a certain time frame, or else the transaction key is no longer valid.

19. A method as claimed in claim 1 wherein said first or said second transaction key includes a time feature so that information stored therein is destroyed after a pre-set time period if it has not been transferred.

20. A method as claimed in claim 1 wherein contact between the information requestor and the central party, or between the central party and the information source, is established in person, or by using a standard telephone, an Internet-enabled cellular telephone, a personal digital assistant (PDA), an IVR (interactive voice response) application, a computer with a direct link between the relevant parties, or using a computer or any device which can gain access to an networked system.

21. A method as claimed in claim 1 wherein at least a part of said networked system includes the system currently referred to as the Internet.

22. A method as claimed in claim 1 wherein contact between the information requestor, the central party and/or the information source, and contact with the computerized system for establishing the transaction key, is conducted using software and optionally hardware, designed to facilitate correspondence between the parties.

23. A method as claimed in claim 1 wherein said second transaction key is identical to said first transaction key.

24. A method for the secure transfer of information electronically, which method comprises the steps of:
(a) having an information requestor prepare a first request for information and providing said first request and a first transaction key related to said first request, to a central party;
(b) having said central party prepare a second request for said information and providing said second request and said first transaction key related to said second request, to an information source;
(c) having said information source provide said information and having said information source relate said information to said first transaction key;
(d) having said information requestor access said information related to said first transaction key.

25. A method as claimed in claim 1 wherein said central party is not given the ability to review or change the information provided by said information source.

26. A method as claimed in claim 1 wherein alerts are generated to any one of, or all of, the information source, information requester, and/or the central party, to indicate the transfer of information.

27. A method as claimed in claim 21 wherein said alerts are in the form of e-mail messages, form letters, or facsimiles.
